(19) United States
(12) Patent Application Publication
(10) Pub. No.: US 2024/0322893 A1
(43) Pub. Date: Sep. 26, 2024

(54) METHOD, A DEVICE, COMPUTER EQUIPMENT, AND COMPUTER-READABLE STORAGE MEDIUM FOR PERFORMING ANTENNA CONTROL

(71) Applicant: SAMSUNG ELECTRONICS CO., LTD., Suwon-si (KR)

(72) Inventors: Ruoxi ZHANG, Suzhou Industrial Park (CN); Sishi WANG, Suzhou Industrial Park (CN)

(21) Appl. No.: 18/599,789

(22) Filed: Mar. 8, 2024

(30) Foreign Application Priority Data
Mar. 24, 2023 (CN) 202310302233.6

(51) Int. Cl. H04B 7/08

(52) U.S. Cl. CPC H04B 7/0817

(57) ABSTRACT

An antenna control method and device, a computer equipment and a computer-readable storage medium are provided. The antenna control method includes determining a number of receiving antennas currently in use, changing the number of receiving antennas currently in use, according to a predetermined condition. The predetermined condition is related to a Rank Indicator (RI) assigned by a network or Reference Signal Receiving Powers (RSRPs) of the receiving antennas.

### CROSS-REFERENCE TO RELATED APPLICATION

The present application claims priority under 35 U.S.C. § 119 to Chinese Patent Application No. 202310302233.6, filed on Mar. 24, 2023, the entire contents of which are herein incorporated by reference.

### TECHNICAL FIELD

The present disclosure relates to antenna control and, more specifically, to an antenna control method, an antenna control device, computer equipment for performing antenna control, and a computer-readable storage medium for performing antenna control.

### DISCUSSION OF THE RELATED ART

With the development of technology, a portable electronic apparatus has become a necessity in peoples' lives. However, as a standby time of the electronic apparatus becomes shorter and shorter with increased frequency of use of the electronic apparatus and the miniaturization of devices, decreasing power consumption while ensuring a normal provision of services is a key concern. In a communication process of the electronic apparatus, a plurality of antennas are often used for the communication, and the use of these antennas increases energy consumption. Therefore, it is important to save energy by flexibly switching the number of antennas that are in use according to actual needs.

### SUMMARY

An antenna control method includes determining a number of receiving antennas currently in use and changing the number of the receiving antennas currently in use, according to a predetermined condition. The predetermined condition is related to a Rank Indicator (RI) assigned by a network or Reference Signal Receiving Powers (RSRPs) of the receiving antennas.

An antenna control device includes an antenna determination unit configured to determine a number of receiving antennas currently in use and an antenna control unit configured to change the number of receiving antennas currently in use, according to a predetermined condition. The predetermined condition is related to a Rank Indicator (RI) assigned by a network or Reference Signal Receiving Powers (RSRPs) of the receiving antennas.

### BRIEF DESCRIPTION OF THE DRAWINGS

The above and other aspects and features of embodiments of the present disclosure will be more apparent through the following description in combination with the accompanying drawings, in which:

FIG. 1 is a diagram showing an application scenario of an embodiment of the present disclosure;

FIG. 2 is a flowchart showing an antenna control method in the related art;

FIG. 3 is a flowchart showing an antenna control method according to an embodiment of the present disclosure;

FIGS. 4A-4C are flowcharts showing an antenna control method according to an embodiment of the present disclosure;

FIGS. 5A-5C are flowcharts showing an antenna control method according to an embodiment of the present disclosure;

FIG. 6 is a flowchart showing an operation method of a first timer according to an embodiment of the present disclosure;

FIG. 7 is a flowchart showing an operation method of a second timer according to an embodiment of the present disclosure;

FIG. 8 is a flowchart showing an operation method of a third timer according to an embodiment of the present disclosure;

FIG. 9 is a flowchart showing an operation method of a fourth timer according to an embodiment of the present disclosure;

FIG. 10 is a timing chart showing an operation of a third timer and a fourth timer according to an embodiment of the present disclosure;

FIG. 11 is a diagram showing an example of an antenna control method according to an embodiment of the present disclosure;

FIG. 12 is a diagram showing an example of an antenna control method according to an embodiment of the present disclosure; and

FIG. 13 is a diagram showing an antenna control terminal according to an embodiment of the present disclosure.

### DETAILED DESCRIPTION OF THE DRAWINGS

In order to enable ordinary people in the art to better understand the technical solution of the disclosure, technical solutions in the embodiments of the disclosure will be described clearly and completely in combination with the accompanying drawings.

The terms “include” or “comprise” used in this specification indicate the existence of the stated features, whole, steps, operations, elements, components and/or combinations thereof, but do not exclude the existence or addition of one or more other features, whole, steps, operations, elements, components and/or combinations thereof. It should be understood that although the terms “first”, “second”, “third”, “fourth” and the like are used to describe various objects, the objects should not necessarily be limited by these terms. These terms are used to distinguish one object from another. For example, the first object may be referred to as the second object without departing from the scope of the present disclosure; and similarly, the second object may also be referred to as the first object.

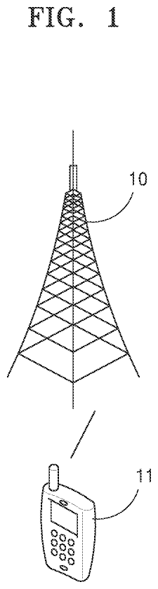

FIG. 1 is an example showing an application scenario of an embodiment of the present disclosure.

The embodiment of the present disclosure may be applied to a scenario where an electronic device communicates with a base station. According to the embodiment of the present disclosure, the electronic device may be a mobile terminal 11 as shown in FIG. 1, or may also include at least one of a smart phone, a tablet personal computer (PC), a mobile phone, a video phone, an e-book reader, a desktop PC, a laptop computer, a netbook computer, a workstation, a server, a personal digital assistant (PDA), a portable multimedia player (PMP), an MP3 player, a mobile medical device, a camera, a wearable device (such as, smart watch, smart bracelet, etc.), etc. but not necessarily limited to this. According to the embodiment of the present disclosure, the base station for communicating with the terminal is not necessarily limited to a base station 10 shown in FIG. 1, and may also include any device at a network side for communicating with the terminal so that the terminal receives signals by using receiving antennas. It should be understood that the above application scenarios are only examples, and the embodiments according to the present disclosure are not necessarily limited to the above application scenarios.

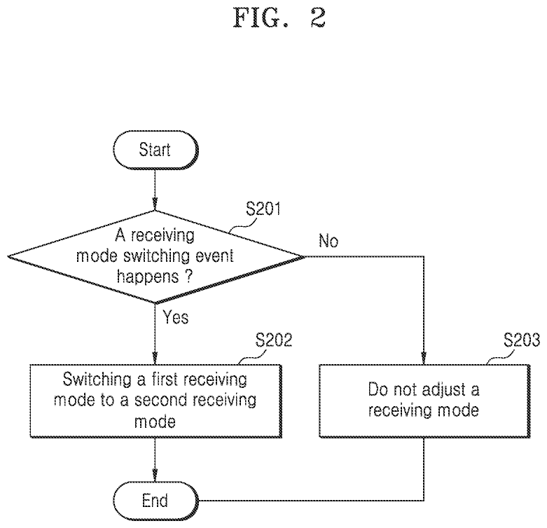

In the related art, when the base station 10 communicates with the electronic device 11. the electronic device 11 may switch the antenna by the antenna control method shown in FIG. 2, and may receive a signal transmitted by the base station. FIG. 2 is a flowchart showing an antenna control method in a related art. Referring to FIG. 2, when a terminal receives a signal, whether a receiving mode switching event happens is determined in step S201. When a receiving mode switching event happens, the terminal switches a receiving mode from a first receiving mode to a second receiving mode in step S202, wherein the first receiving mode may be, for example, a use number of receiving antennas is 4, and the second receiving mode may be, for example, the number of receiving antennas currently in use is 2. For example, in response to the receiving mode switching event, the terminal decreases the number of receiving antennas turned on from 4 to 2. When no receiving mode switching event happens, the terminal does not adjust the receiving mode in step S203. Here, the receiving mode switching event may be related to a Reference Signal Receiving Power (RSRP). It may be seen that the related art has a defect that the control method is single and cannot be applied to multiple scenarios. For example, the related art only performs antenna switching in response to the occurrence of a specific switching event, and the switched mode is fixed, which is particularly unfavorable for a practical application of a plurality of antennas.

In addition, there are other shortcomings in related technologies. For example, since a control standard for a Rank Indicator (RI) assigned by a network is rigid, if the network is not configured with a Sounding Reference Signal (SRS) resource, the network assigns RI based on a rank reported by the terminal, and there will be a problem that the network cannot assign a higher RI to transmit more data. For example, when the receiving mode switching event is related to RSRP, a short-term fluctuation of RSRP caused by wireless signal interference may lead to frequent antenna switching, and such repeated frequent switching will consume more power.

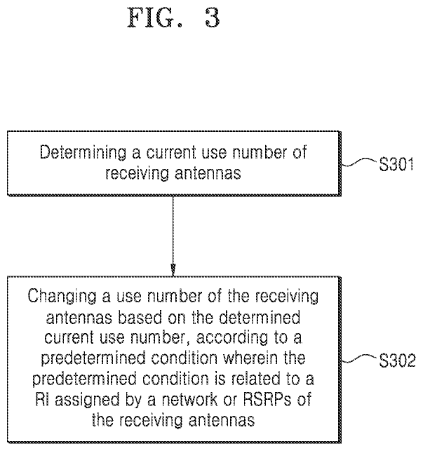

In consideration of the above problems in related technologies, the present disclosure provides an antenna control method, an antenna control device, a computer equipment for controlling antenna, and a computer-readable storage medium for controlling antenna. An embodiment according to the present disclosure will be described below with reference to FIGS. 3 to 13.

FIG. 3 is a flowchart showing an antenna control method according to an embodiment of the present disclosure.

Referring to FIG. 3, in step S301, a number of receiving antennas currently in use is determined.

In step S302, a number of receiving antennas in use is changed, according to a predetermined condition, wherein the predetermined condition is related to a Rank Indicator (RI) assigned by a network or Reference Signal Receiving Powers (RSRPs) of the receiving antennas.

Here, the changing of the number of receiving antennas currently in use may include: decreasing the number of receiving antennas currently in use, increasing the number of receiving antennas currently in use and/or maintaining the number of receiving antennas currently in use. Alternatively, the decreasing of the number of receiving antennas currently in use may include decreasing the number of receiving antennas currently in use to a minimum number of receiving antennas in use, and/or decreasing the number of receiving antennas currently in use to a predetermined value. For example, the minimum of the number of receiving antennas currently in use may be 1, but the minimum is not necessarily limited to this, or it may be any integer value preset as needed. Alternatively, the increasing of the number of receiving antennas currently in use may include restoring the number of receiving antennas currently in use to the maximum (for example, turning on all receiving antennas to receive signals), and/or increasing the number of receiving antennas currently in use to a predetermined value.

Alternatively, the antenna control method also includes restoring or maintaining the number of receiving antennas currently in use to the maximum based on the receiving antennas being used to receive an amount of data that is above a predetermined threshold. Alternatively, whether the receiving antennas are used to receive the amount of data that is above the predetermined threshold may be determined. When the receiving antennas are used to receive the an amount of data that is above a predetermined threshold, the receiving antennas with the maximum receiving capacity is required. Therefore, the number of receiving antennas currently in use is restored to the maximum, or the number of receiving antennas currently in use, which is the maximum, is maintained. For example, as many receiving antennas as possible are used to receive a large amount of data, to avoid affecting data transmission efficiency due to a use limitation of the receiving antennas.

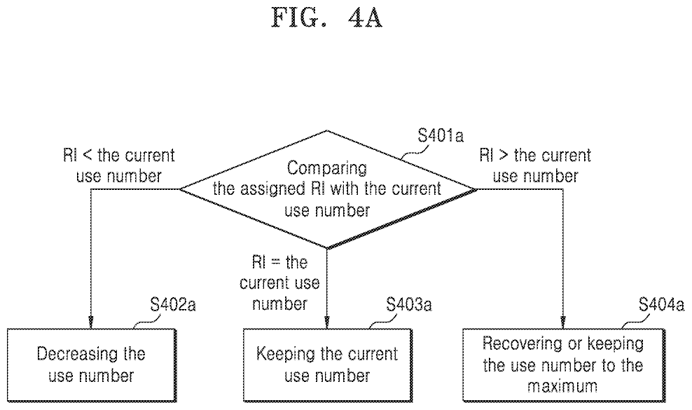

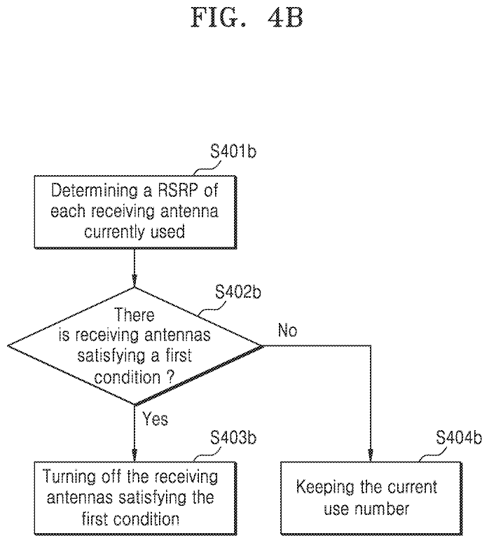

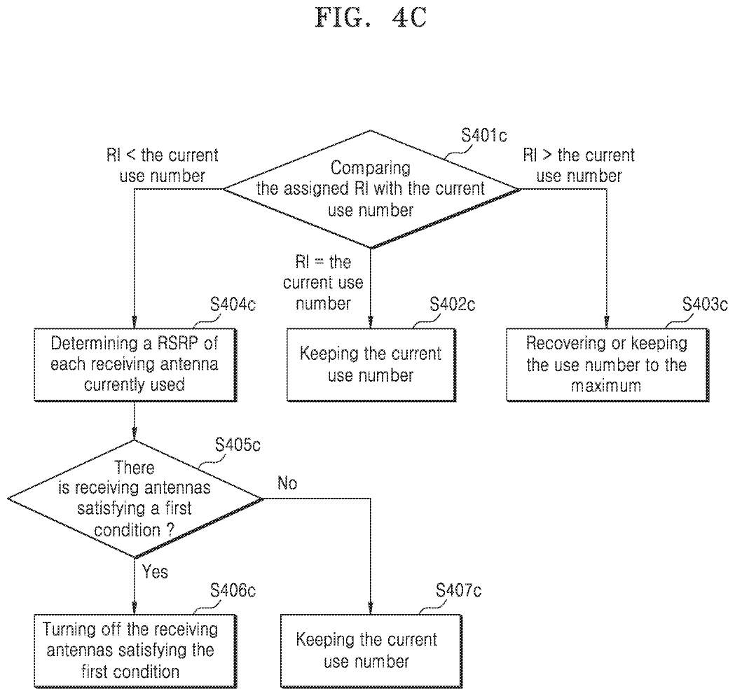

The changing of the number of receiving antennas currently in use in the step S302 will be described in detail below with reference to FIG. 4 later.

The number of antennas currently in use may be flexibly controlled based on actual usage, by performing a corresponding operation of changing the use number of antennas.

The changing the number of receiving antennas currently in use will be described in detail below in combination with FIG. 4.

Element (a) of FIG. 4 is a flowchart showing the changing the number of receiving antennas currently in use according to an embodiment of the present disclosure. Referring to clement (a) of FIG. 4, in step S401a, a value of the RI assigned by the network is compared with the number of receiving antennas currently in use.

When the value of the RI is less than the number of receiving antennas currently in use, the number of receiving antennas currently in use is decreased in step S402a. When the value of the RI is less than the number of receiving antennas currently in use, there may be a receiving antenna which may be turned off, and the number of receiving antennas currently in use may be decreased to the same value as the value of the RI.

Alternatively, the decreasing of the number of receiving antennas currently in use, when the value of the RI is less than the number of receiving antennas currently in use, includes: starting a first timer in response to determining that the value of the RI is less than the number of receiving antennas currently in use; decreasing the number of receiving antennas currently in use to the value of the RI when the first timer exceeds a first predetermined time period.

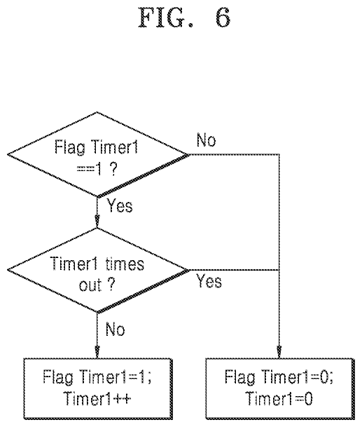

Here, an operation of the first timer will be described in detail with reference to FIG. 6. Referring to FIG. 6, whether the first timer Timer1 is started (Flag Timer1==1) is determined. Whether the first timer Timer1 times out is determined when the first timer Timer1 is started (Flag Timer1=1). The first timer Timer1 continued to be used (Flag Timer1=1; Timer1++) when the first timer Timer1 does not time out. At this time, the number of receiving antennas currently in use may be maintained, or the number of receiving antennas currently in use may be restored to the maximum. The timing is stopped and the first timer Timer1 is reset (Flag Timer1=0; Timer1=0) when the first timer Timer1 times out. At this time, the number of receiving antennas currently in use is decreased to the value of the RI.

The first predetermined time period related to the first timer is a time period for which a state, that the RI assigned by the network is less than the number of receiving antennas in use, lasts. It may be a preset positive value in units of ms, for example, including, but not necessarily limited to, 100 ms, 200 ms, 400 ms, 800 ms or 1000 ms.

By the use of the first timer, the number of the antennas may be decreased only when the receiving antennas satisfy the condition for a period of time, to avoid a problem of frequent switching of the receiving antennas due to a transient or temporary signal interference, thereby decreasing energy consumption.

When the value of the RI is equal to the number of receiving antennas currently in use, the number of receiving antennas currently in use is maintained in step S403a. For example, when the value of the RI assigned by the network is equal to the number of receiving antennas currently in use, it is unnecessary to change the number of receiving antennas in use.

The number of receiving antennas currently in use is restored or maintained to the maximum in step S404a, when the value of the RI is greater than the number of receiving antennas currently in use. When the value of the RI is greater than the number of receiving antennas currently in use, the receiving antennas currently used may be insufficient to receive all signals. Therefore, it is necessary to turn on all receiving antennas to sufficiently receive all signals.

A communication function may be performed with the number of receiving antennas of which the number is equal to or greater than the value of the RI assigned by the network, by flexibly configuring the number of receiving antennas currently in use based on the value of the RI assigned by the network side, which avoids an impact on communication due to insufficient number of the receiving antennas, while a problem of wasting power by performing the communication function with the number of receiving antennas of which the number is greater than the value of the RI may be avoided. In addition, the antenna control method, according to an embodiment of the present disclosure, may also prevent a risk that the network cannot assign a higher RI.

Element (b) of FIG. 4 is a flowchart showing the changing of the number of receiving antennas currently in use according to an embodiment of the present disclosure. Referring to element (b) of FIG. 4, a RSRP of each receiving antenna currently used is determined in step S401b

In step S402b, it is determined whether there is one or more receiving antennas satisfying the first condition based on the RSRP of each receiving antenna.

Alternatively, the first condition is that, the RSRP of each of the one or more receiving antennas is less than a first RSRP threshold value, and a RSRP difference between each of the one or more receiving antennas and any other receiving antenna is greater than a second RSRP threshold value. Alternatively, the first RSRP threshold value may be used to determine whether a signal received by the receiving antenna is a useless noise or interference, for example, it may be a preset threshold value (such as, −120 dBm). For example, the signal received by the receiving antenna satisfying the condition, that the RSRP is less than the first RSRP threshold value, may be a useless noise or interference signal. Alternatively, the second RSRP threshold value may be used to determine whether there is a sufficiently large difference between the RSRP of the signal received by the receiving antenna and the RSRP of the signal received by other receiving antenna, for example, the signal received by the receiving antenna, of which the RSRP is less than the first RSRP threshold value and the RSRP difference from any other receiving antenna is greater than the second RSRP threshold value is very likely to be a useless signal, and the receiving antenna, is very likely to be a receiving antenna which is unnecessary to be turned on. Here, the second RSRP threshold value may be a preset threshold value (such as, 20 dB).

As such, the one or more receiving antennas satisfying the first condition are most likely to be receiving antennas that are unnecessary in the communication process, and the use of the one or more receiving antennas satisfying the first condition may be temporarily stopped to decrease power consumption.

When there is the one or more receiving antennas satisfying the first condition, the one or more receiving antennas are turned off in step S403b. Here, as described above, a signal received by the receiving antenna satisfying the first condition may be a signal that is unnecessary at present. Therefore, the receiving antennas satisfying the first condition may be temporarily turned off.

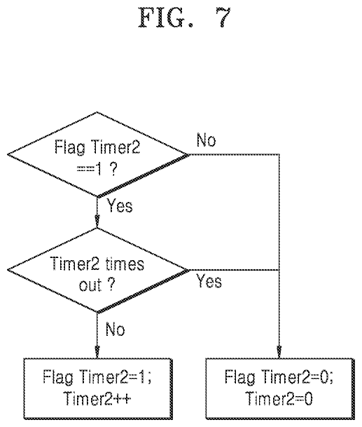

Alternatively, the turning off the one or more receiving antennas includes: starting a second timer in response to determining that there are the one or more receiving antennas satisfying the first condition; turning off the one or more receiving antennas when the second timer exceeds a second predetermined time period. Here, an operation of the second timer will be described in detail with reference to FIG. 7. Referring to FIG. 7, whether the second timer Timer2 is started (Flag Timer2 ==1) is determined. Whether the second timer Timer2 times out is determined when the second timer Timer2 is started (Flag Timer2=1). the second timer Timer2 continues to run (Flag Timer2=1; Timer2++) when the second timer Timer2 does not time out. At this time, alternatively, the current used number of receiving antennas may be maintained. The timing is stopped and the second timer Timer2 is reset (Flag Timer2=0; Timer2=0) when the second timer Timer2 times out. At this time, the one or more receiving antennas satisfying the first condition are turned off.

The second predetermined time period related to the second timer is a time period for which a state, that a part of the receiving antennas satisfy the first condition, lasts. It may be a preset positive value, for example, including, but not necessarily limited to, 100 ms, 200 ms, 400 ms, 800 ms or 1000 ms.

By the use of the second timer, the number of the antennas will be decreased only when the receiving antennas satisfy the condition for a period of time, to avoid a problem of frequent switching of the receiving antennas due to a transient or sudden signal interference (for example, a short-term fluctuation of RSRP caused by a wireless signal interference affected by the environment will lead to repeated switching of the receiving antennas), thereby decreasing energy consumption.

The number of receiving antennas currently in use of the receiving antennas is maintained, in step S404b, when there is no one or more receiving antennas satisfying the first condition. When there is no receiving antenna satisfying the first condition, the RSRPs of the receiving antennas currently used are greater than the first RSRP threshold value and the RSRP differences between each other are less than the second RSRP threshold value. At this time, the signals received by all receiving antennas are valid signals, the number of receiving antennas currently in use of the receiving antennas may be maintained to ensure that it may continue receiving the signals effectively.

Compared with the related art, the antenna control method of the present disclosure of determining whether the receiving antenna is effective to control the number of antennas, by using the RSRPs of the antennas and the RSRP differences between the antennas, is more accurate.

Although the changing of the number of receiving antennas currently in use are described above in the embodiment of element (a) of FIG. 4 and the embodiment of element (b) of FIG. 4, respectively, the embodiment in element (a) of FIG. 4 and the embodiment in element (b) of FIG. 4 may also be applicable to change the number of receiving antennas currently in use together. This will be described below with reference to element (c) of FIG. 4. Element (c) of FIG. 4 is a diagram showing the changing the number of receiving antennas currently in use according to an embodiment of the present disclosure.

Various details in the embodiment of element (a) of FIG. 4 and the embodiment of element (b) of FIG. 4 may be applicable to the embodiment of element (c) of FIG. 4.

Referring to element (c) of FIG. 4, the value of the RI assigned by the network is compared with the number of receiving antennas currently in use of the receiving antennas in step S401c.

The number of receiving antennas currently in use of the receiving antennas is maintained in step S402c, when the value of the RI is equal to the number of receiving antennas currently in use.

The number of receiving antennas currently in use is restored or maintained to the maximum in step S403c, when the value of the RI is greater than the number of receiving antennas currently in use.

A RSRP of each receiving antenna currently used is determined in step S404c, when the value of the RI is less than the number of receiving antennas currently in use. Whether there is one or more receiving antennas satisfying the first condition is determined based on the RSRP of each receiving antenna in step S405c. The one or more receiving antennas are turned off in step S406c, when there is the one or more receiving antennas satisfying the first condition. The number of receiving antennas currently in use of the receiving antennas is maintained in step S407c, when there is no one or more receiving antennas satisfying the first condition.

By adjusting the number of the receiving antennas based on RI and RSRP together, many application scenarios may be covered. For example, performing the steps related to RSRP based on the value of the RI less than the number of receiving antennas currently in use firstly may greatly increase the accuracy of antenna control, to avoid affecting data transmission due to improper antenna switching.

Although it is shown here that the steps related to controlling the number of the receiving antennas based on the RI is prior to the steps related to controlling the number of the receiving antennas based on the RSRP, the present disclosure is not necessarily limited to this. The steps related to controlling the number of the receiving antennas based on the RI may also be performed after the steps related to controlling the number of the receiving antennas based on the RSRP, or may be performed simultaneously with the steps related to controlling the number of the receiving antennas based on the RSRP.

For example, since the control standard is rigid, if the network is not configured with a Sounding Reference Signal (SRS) resource, the network will assign the RI based on a rank reported by a terminal. Therefore, there will be a problem that the network cannot assign a higher RI to transmit more data.

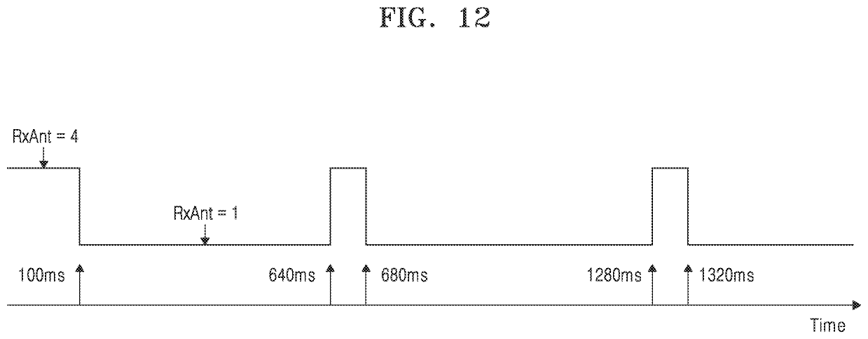

In order to solve the above problems and other shortcomings, according to the present disclosure, the antenna control method further includes: starting a third timer , when a third time period timed by the third timer exceeds a third predetermined time period, in response to determining that the number of receiving antennas currently in use is not the maximum, restoring the number of receiving antennas currently in use to the maximum, and restarting the third timer Alternatively, the third timer may be started based on a predetermined frame number, a predetermined sub-frame number, and a predetermined timeslot, for example, when the predetermined frame number, the predetermined sub-frame number, and the predetermined time slot are all 0 (for example, at 0 ms in FIG. 12). Whenever the third timer of the receiving antennas satisfies a predetermined cycle, if the use number is not the maximum, the number of receiving antennas currently in use is restored to the maximum, otherwise the number of receiving antennas currently in use of the receiving antenna as the maximum is maintained, and the third timer is restarted. For example, it is guaranteed that the antennas may be regularly called back to the maximum use number of the antennas (for example, 4 antennas), so that the terminal may report that the rank is 4. In this case, if more data needs to be transmitted, the network may change the value of the assigned RI to 4. As such, a problem of inefficient transmission caused by the network not allocating a higher RI may be avoided.

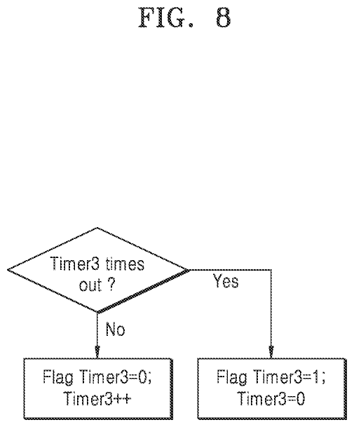

Here, an operation of the third timer will be described in detail with reference to FIG. 8. Referring to FIG. 8, when the third timer Timer3 is started, a flag Flag Timer3 is used to determine whether the third timer Timer3 times out. When the third timer Timer3 does not time out, Flag Timer3=0 and Timer3++. At this time, alternatively, the number of receiving antennas currently in use may be maintained. When the third timer Timer3 times out, Flag Timer3=1 and Timer3=0. At this time, the number of receiving antennas currently in use is restored to the maximum, and the third timer Timer3 is restarted. The third predetermined time period related to the third timer is a period to periodically recover the receiving antennas to the maximum number, and the third predetermined time period may be a preset positive value, for example, including, but not necessarily limited to, 40 ms, 80 ms, 160 ms, 320 ms, 640 ms, 1280 ms or 10240 ms.

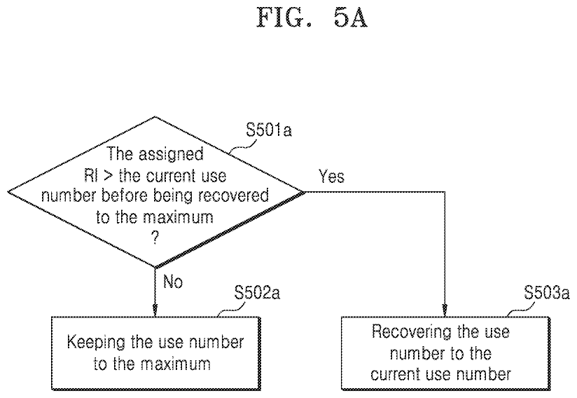

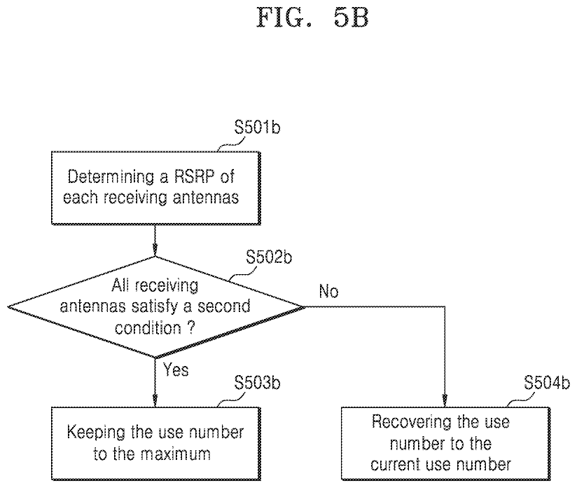

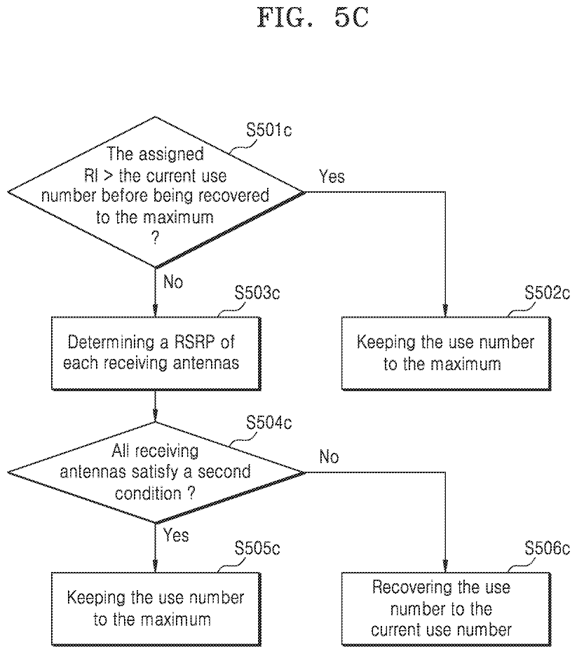

The steps after restoring the number of receiving antennas currently in use to the maximum will be described in detail below in combination with FIG. 5.

Element (a) of FIG. 5 is a flowchart showing an antenna control method according to an embodiment of the present disclosure after the number of receiving antennas currently in use is restored to the maximum.

Referring to element (a) of FIG. 5, whether the value of the RI assigned by the network is greater than the number of receiving antennas currently in use before being restored to the maximum is determined in step S501a.

The number of receiving antennas currently in use is maintained to the maximum in step S502a, when the value of the RI is greater than the number of receiving antennas currently in use. When the value of the RI assigned by the network is greater than the number of receiving antennas currently in use before being restored to the maximum, the previous use number may be insufficient to receive signals, and it is necessary to continue maintaining the number of receiving antennas currently in use that has been restored to the maximum.

The number of receiving antennas currently in use is restored in step S503a, when the value of the RI is not greater than the number of receiving antennas currently in use. When the value of the RI assigned by the network is less than or equal to the number of receiving antennas currently in use before being restored to the maximum, the previous use number is sufficient to receive signals, and the number of receiving antennas currently in use may be restored to the previous current use number.

Whether it is necessary to recover the receiving antennas to the previous use number is determined by comparing the value of the RI with the use number of antennas before being regularly restored to the maximum, the receiving antennas that is periodically called back to the maximum number is adjusted by this manner, which avoids always turning on the maximum number of the receiving antennas after the use number of the antennas is restored to the maximum based on the third predetermined time period, to decrease power consumption.

Element (b) of FIG. 5 is a flowchart showing an antenna control method according to an embodiment of the present disclosure after the number of receiving antennas currently in use is restored to the maximum.

Referring to element (b) of FIG. 5, in step S501b, a RSRP of each receiving antenna is determined.

Whether all receiving antennas satisfy a second condition is determined based on the RSRP of the each receiving antenna in step S502b.

Alternatively, the second condition is that, the RSRP of each of all the receiving antennas is greater than a third RSRP threshold value, and a RSRP difference between the each receiving antenna and any other receiving antenna is less than a fourth RSRP threshold value.

Alternatively, the third RSRP threshold value may be used to determine whether a signal received by the receiving antenna is a useless noise or interference signal, for example, it may be a preset threshold value (such as, −120 dBm) as needed. For example, the signal received by the receiving antenna satisfying the condition that the RSRP is greater than the third RSRP threshold value is not considered as useless noise or interference, for example, the received signal is a valid signal

Alternatively, the fourth RSRP threshold value may be used to determine whether the RSRP of the signal received by the receiving antenna has only a small difference from the RSRPs of the signals received by other receiving antennas, for example, all the receiving antennas are necessary to be turned on only when the RSRPs of all the receiving antennas are greater than the third RSRP threshold value and the RSRP difference with any other receiving antenna is less than the fourth RSRP threshold value. Here, the fourth RSRP threshold value may be a preset threshold value (such as, 20 dB).

Alternatively, the third RSRP threshold value may be the same as or different from the first RSRP threshold value described above. The fourth RSRP threshold value may be the same as or different from the second RSRP threshold value described above.

As such, all the receiving antennas satisfying the second condition are the receiving antennas that is necessary to be used in the communication process, and it needed that the maximum number of the receiving antennas is maintained open to receive signals with maximum efficiency.

The number of receiving antennas currently in use is maintained to the maximum in step S503b, when all the receiving antennas satisfy the second condition. The number of receiving antennas currently in use is restored in step S504b, when not all the receiving antennas satisfy the second condition.

Whether all the received signals are valid is determined based on the RSRPs of all the receiving antennas, to determine whether it is necessary to recover the receiving antennas to the previous use number. The receiving antennas that is periodically called back is adjusted by this manner, which avoids always turning on the maximum number of the receiving antennas after the use number of the antennas is restored to the maximum based on the third predetermined time period, to decrease power consumption. Compared with the related art, the control manner that determines whether the receiving antenna is valid by using the RSRP of the antenna and the RSRP difference of the antenna so as to control the number of the antennas is more accurate.

Alternatively, the restoring of the number of receiving antennas currently in use in step S503a or step S504b further includes: starting a fourth timer, in response to determining that the value of the RI is not greater than the number of receiving antennas currently in use or in response to determining that not all the receiving antennas satisfy the second condition; restoring the number of receiving antennas currently in use when the fourth timer exceeds a fourth predetermined time period.

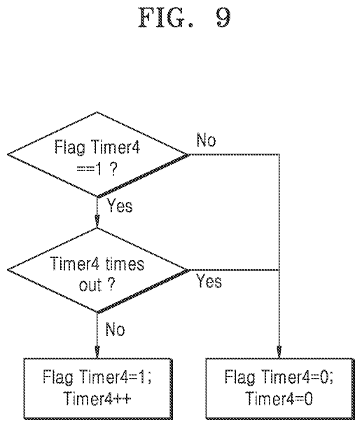

Here, an operation of the fourth timer will be described in detail with reference to FIG. 9. Referring to FIG. 9, whether the fourth timer Timer4 is started (Flag Timer4==1) is determined. Whether the fourth timer Timer4 times out is determined when the fourth timer Timer4 is started (Flag Timer4=1). The fourth timer Timer4 continues to run (Flag Timer4=1; Timer4++) when the fourth timer Timer4 does not time out. At this time, alternatively, the number of receiving antennas currently in use may be maintained. The timing is stopped and the fourth timer Timer4 is reset (Flag Timer4=0; Timer4=0) when the fourth timer Timer4 times out. At this time, the number of receiving antennas currently in use is restored.

The fourth predetermined time period related to the fourth timer is a period of restoring, the antennas being restored to the maximum number, to the original state, wherein the period may be a preset positive value, for example, including, but not necessarily limited to, 40 ms, 80 ms, 160 ms, 320 ms, 640 ms, 1280 ms or 10240 ms. By the use of the fourth timer, the number of the antennas is restored only when the receiving antennas satisfy the above condition for a period of time, to avoid a problem of frequent switching of the receiving antennas due to a transient or temporary signal interference, thereby decreasing energy consumption.

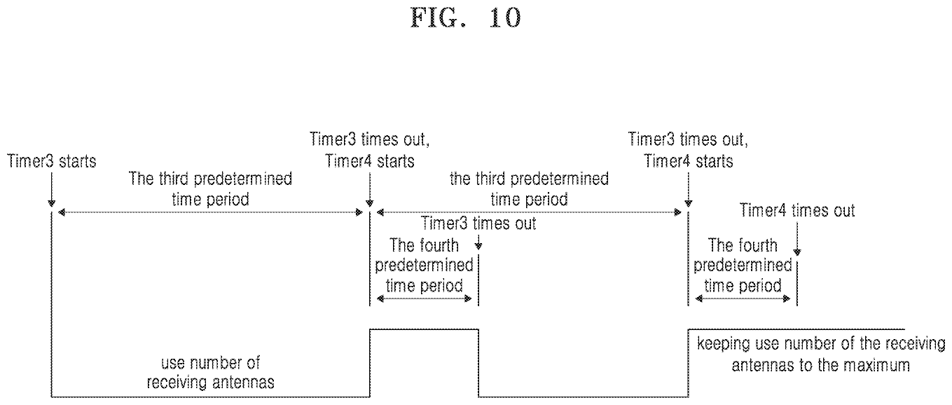

FIG. 10 is a timing chart showing an operation of a third timer and a fourth timer according to an embodiment of the present disclosure. Referring to FIG. 10, the third timer Timer3 is started at the initial time. The use number of receiving antennas is restored to the maximum in response to a fact that the number of receiving antennas currently in use of the receiving antennas is not the maximum when the third timer Timer3 times out, and the third timer Timer3 is restarted.

The number of the receiving antennas will be restored to the previous current use number, when the value of the assigned RI is less than or equal to the number of receiving antennas currently in use of the receiving antennas which is not the maximum, or a state that not all the RSRPs of receiving antennas satisfy the second condition lasts for a fourth predetermined period of time.

Then, the above process is repeated. The number of receiving antennas currently in use will be restored to the maximum in response to the fact that the number of receiving antennas currently in use is not the maximum, when the third timer Timer3 times out.

The number of the receiving antennas is maintained to the maximum, when the value of the assigned RI is greater than the number of receiving antennas currently in use is not the maximum, or a state that the RSRPs of all the receiving antennas satisfy the second condition lasts for the fourth predetermined time period.

Although the steps of the antenna control method after restoring the number of receiving antennas currently in use to the maximum are described above in the fourth embodiment of element (a) and the embodiment of element (b) of FIG. 5, respectively, the embodiment in element (a) of FIG. 5 and the embodiment in element (b) of FIG. 5 may also be applicable to the step of restoring the number of receiving antennas currently in use to the maximum together. This will be described below with reference to element (c) of FIG. 5. Element (c) of FIG. 5 is a flowchart showing an antenna control method according to an embodiment of the present disclosure after the number of receiving antennas currently in use is restored to the maximum.

Various details in the embodiment of element (a) of FIG. 5 and the embodiment of element (b) of FIG. 5 may be applied to the embodiment of element (c) of FIG. 5.

Referring to element (c) of FIG. 5, whether the value of the RI assigned by the network is greater than the number of receiving antennas currently in use before being restored to the maximum is determined in step S501c.

The number of receiving antennas currently in use is maintained to the maximum in step S502c, when the value of the RI is greater than the number of receiving antennas currently in use.

A RSRP of each receiving antenna is determined in step S503c, when the value of the RI is not greater than the number of receiving antennas currently in use. Whether all the receiving antennas satisfy the second condition is determined based on the RSRP of each receiving antenna in step S504c. The number of receiving antennas currently in use is maintained to the maximum in step S505c, when all the receiving antennas satisfy the second condition.

The number of receiving antennas currently in use is restored in step S506c, when not all the receiving antennas satisfy the second condition.

By adjusting the number of the receiving antennas based on RI and RSRP together, many application scenarios may be covered In particular, determining whether to recover the use number to the previous current use number, by double conditions, may more accurately avoid affecting data transmission due to the too few number of antennas that are turned on.

Although it is shown here that the steps related to controlling the number of the receiving antennas based on the RI is prior to the steps related to controlling the number of the receiving antennas based on the RSRP, the present disclosure is not necessarily limited to this. The steps related to controlling the number of the receiving antennas based on the RI may also be performed after the step related to controlling the number of the receiving antennas based on the RSRP, or may be performed simultaneously with the steps related to controlling the number of the receiving antennas based on the RSRP.

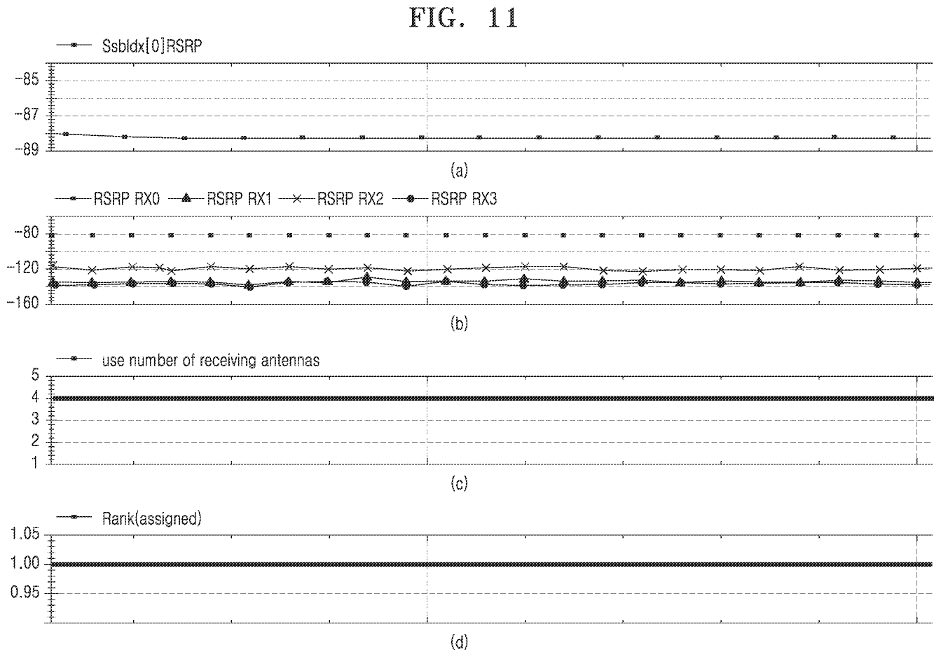

The antenna control method according to the present disclosure will be described below with reference to FIGS. 11 and 12 and taking the embodiment of FIG. 4 and the embodiment of FIG. 5 as examples. FIGS. 11 and 12 are diagrams showing examples of antenna control methods according to an embodiment of the present disclosure.

As shown in FIG. 11, the total number of receiving antennas is 4, and different broken lines represent different receiving antennas. Element (a) of FIG. 11 shows the total RSRP value of the four receiving antennas. Element (b) of FIG. 11 shows RSRP values of each receiving antenna (i.e., the first receiving antenna (RX0), the second receiving antenna (RX1), the third receiving antenna (RX2) and the fourth receiving antenna (RX3)). Element (d) of FIG. 11 shows that a rank assigned by the network is always 1.

As an example, suppose that the first and second predetermined time periods are 100 ms, the third predetermined time period is 640 ms, and the fourth predetermined time period is 40 ms, the first RSRP threshold value and the third RSRP threshold value are −120 dBm, the second RSRP threshold value and the fourth RSRP threshold value are 20 dB, and the minimum and maximum of the number of receiving antennas currently in use (RxAnt) are 1 and 4.

Since the current four receiving antennas are not used to receive an amount of data that is above a predetermined threshold, and the number of receiving antennas currently in use is not the minimum of 1, the antenna control method according to the embodiment of the present disclosure may be used to decrease the number of receiving antennas in use.

The first timer is started in response to a fact that the assigned RI is less than the number of receiving antennas currently in use. In addition, as shown in FIG. 11, RSRPs of RX1, RX2 and RX3 are less than −120 dBm, and RSRP differences between RX0 and RX1, RX0 and RX2, and RX0 and RX3 are greater than 20 dB. At this time, the second timer is started. As shown in FIG. 12, after 100 ms (for example, at 100 ms in FIG. 12), both the first timer and the second timer time out, RX2, RX3, and RX4 are turned off, and the number of receiving antennas currently in use (RxAnt) is changed from 4 to 1.

At 0 ms (at this time, the frame number, sub-frame number and timeslot are all 0), the third timer is started. After 640 ms (for example, at 640 ms in FIG. 12), the number of the receiving antennas is restored to 4 in response to a fact that the number of the receiving antennas is not 4 at this time, and the third timer is restarted.

The fourth timer is started in response to the RI assigned by the network being equal to the previous number of receiving antennas in use, or in response to the RSRPs of RX1, RX2 and RX3 being less than −120 dBm, and the RSRP differences between RX0 and RX1, RX0 and RX2, and RX0 and RX3 being greater than 20 dB. After 40 ms (i.e. 680 ms in FIG. 12), the number of the receiving antennas in use is restored to 1.

After the third timer is restarted for 640 ms (for example, at 1280 ms in FIG. 12), the number of the receiving antennas in use is adjusted to 4, and after 40 ms (for example, at 1320 ms in FIG. 12), the number of the receiving antennas in use is restored to 1. At this time, the third timer restarts timing and continues timing at a period of 640 ms.

The antenna control method, according to the embodiment of the present disclosure, may flexibly switch the number of the antennas, which is capable of decreasing power consumption without affecting signal transmission, and meets the actual needs of users.

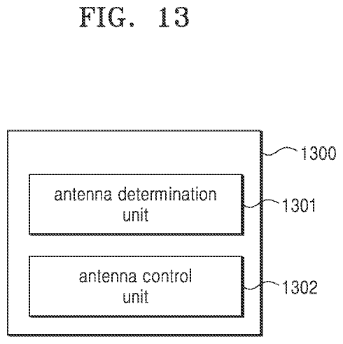

FIG. 13 is a diagram showing an antenna control terminal 1300 according to an embodiment of the present disclosure.

Referring to FIG. 13, the antenna control device 1300 may include an antenna determination unit 1301 and an antenna control unit 1302. The antenna determination unit 1301 is configured to determine a number of receiving antennas currently in use. The antenna control unit 1302 is configured to change a number of receiving antennas in use, according to a predetermined condition. The predetermined condition is related to a RI assigned by a network or RSRPs of the receiving antennas.

For example, the antenna determination unit 1301 may perform the above step S301, and the antenna control unit 1302 may perform the above step S302. Regarding to the details of the operations involved in the above antenna control method, they may be assumed to be at least similar to corresponding details described above with respect to FIGS. 3 to 9.

Alternatively, the antenna control unit 1302 is also configured to recover or keep the number of receiving antennas currently in use to the maximum based on the receiving antennas being used to receive an amount of data that is above a predetermined threshold.

Alternatively, the antenna control unit 1302 is configured to change the number of receiving antennas currently in use, according to the predetermined condition, by: comparing a value of the RI assigned by the network with the number of receiving antennas currently in use, decreasing the number of receiving antennas currently in use when the value of the RI is less than the number of receiving antennas currently in use, maintaining the number of receiving antennas currently in use when the value of the RI is equal to the number of receiving antennas currently in use, and restoring or maintaining the number of receiving antennas currently in use to the maximum when the value of the RI is greater than the number of receiving antennas currently in use.

Alternatively, when the value of the RI is less than the number of receiving antennas currently in use, the antenna control unit 1302 is configured to decrease the number of receiving antennas currently in use by: starting a first timer in response to determining that the value of the RI is less than the number of receiving antennas currently in use; and decreasing the number of receiving antennas currently in use to the value of the RI when the first timer exceeds a first predetermined time period.

Alternatively, the antenna control unit 1302 is configured to change the number of receiving antennas currently in use, according to the predetermined condition, by: determining a RSRP of each receiving antenna currently used; determining whether there is one or more receiving antennas satisfying a first condition, based on the RSRP of the each receiving antenna; turning off the one or more receiving antennas when there is the one or more receiving antennas satisfying the first condition; and maintaining the number of receiving antennas currently in use when there is no one or more receiving antennas satisfying the first condition.

Alternatively, the antenna control unit 1302 is configured to turn off the one or more receiving antennas by: starting a second timer in response to determining that there is the one or more receiving antennas satisfying the first condition; and turning off the one or more receiving antennas when the second timer exceeds a second predetermined time period.

Alternatively, the first condition is that, the RSRP of each of the one or more receiving antennas is less than a first RSRP threshold value, and a RSRP difference between each of the one or more receiving antennas and any other receiving antenna is greater than a second RSRP threshold value.

Alternatively, the antenna control unit 1302 is further configured to: start a third timer; whenever a third time period timed by the third timer exceeds a third predetermined time period, in response to determining that the number of receiving antennas currently in use is not the maximum, recover the number of receiving antennas currently in use to the maximum, and restarting the third timer.

Alternatively, the antenna control unit 1302 is further configured to recover the number of receiving antennas currently in use to the maximum by: determining whether the value of the RI assigned by the network is greater than the number of receiving antennas currently in use before being restored to the maximum; maintaining the number of receiving antennas currently in use to the maximum when the value of the RI is greater than the number of receiving antennas currently in use; and restoring the number of receiving antennas currently in use when the value of the RI is not greater than the number of receiving antennas currently in use .

Alternatively, the antenna control unit 1302 is further configured to recover the number of receiving antennas currently in use to the maximum by: determining a RSRP of each receiving antenna; determining whether all receiving antennas satisfy a second condition based on the RSRP of the each receiving antenna; restoring the number of receiving antennas currently in use when not all the receiving antennas satisfy the second condition; and maintaining the number of receiving antennas currently in use to the maximum when all the receiving antennas satisfy the second condition.

Alternatively, the antenna control unit 1302 is further configured to recover the number of receiving antennas currently in use by: starting a fourth timer, in response to determining that the value of the RI is not greater than the number of receiving antennas currently in use or in response to determining that not all the receiving antennas satisfy the second condition; and restoring the number of receiving antennas currently in use when the fourth timer exceeds a fourth predetermined time period.

Alternatively, the second condition is that, the RSRP of each of all the receiving antennas is greater than a third RSRP threshold value, and a RSRP difference between the each receiving antenna and any other receiving antenna is less than a fourth RSRP threshold value.

The present disclosure provides computer equipment, including at least one processor; and at least one memory storing computer executable instructions, wherein the computer executable instructions, when executed by the at least one processor, cause the at least one processor to execute the antenna control method as described above.

As an example, the computer equipment may be a personal computer (PC), a tablet device, a personal digital assistant, a smartphone, or other devices capable of executing the above set of instructions. Here, the computer equipment does not have to be a single electronic device, but may also be an assembly of any device or circuit that may execute the above instructions (or instruction sets) individually or jointly. The computer equipment may also be a part of an integrated control system or system manager, or may be configured as a portable electronic device that is interfaced with a local or remote (e.g., via wireless transmission).

The processor may run instructions or codes stored in the memory, which may also store data. Instructions and data may also be transmitted and received over the network via a network interface device, which may employ any known transmission protocol.

The memory may be integrated with the processor. For example, a RAM or flash memory may be arranged in an integrated circuit microprocessor or the like. In addition, the memory may include an independent device, such as an external disk drive, storage array, or other storage devices that may be used by any database system. The memory and the processor may be operationally coupled, or may communicate with each other, for example, through an I/O port, a network connection, etc., so that the processor may read files stored in the memory.

In addition, the computer equipment may also include a video display (such as a liquid crystal display) and a user interaction interface (such as a keyboard, mouse, touch input device, etc.). All components of the computer equipment may be connected to each other via a bus and/or network.

The present disclosure provides a computer-readable storage medium, wherein, instructions in the computer-readable storage medium, when executed by at least one processor, cause the at least one processor to execute the antenna control method as described above.

Examples of computer-readable storage media here include: read only memory (ROM), random access programmable read only memory (PROM), electrically erasable programmable read only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM , DVD-R, DVD+R, DVD-RW, DVD+RW, DVD-RAM, BD-ROM, BD-R, BD-R LTH, BD-RE, Blu-ray or optical disc storage, hard disk drive (HDD), solid state disk (SSD), card memory (such as a multimedia card, secure digital (SD) card, or extreme digital (XD) card), magnetic tape, floppy disk, magneto-optical data storage device, optical data storage device, hard disk, solid state disk, and any other devices configured to store the computer applications and any associated data, data files and data structures in a non-transitory manner, and provide the computer applications and any associated data, data files and data structures to a processor or computer so that the processor or computer can execute the computer applications. The computer applications in the above-mentioned computer readable storage medium can be executed in an environment deployed in a computer device such as a client, a host, a proxy device, a server, etc. in addition, in one example, the computer applications and any associated data, data files and data structures are distributed over networked computer systems so that the computer applications and any associated data, data files and data structures are stored, accessed and executed in a distributed manner by one or more processors or computers.

According to embodiments of the present disclosure, computer software may also be provided, and instructions in the computer software may be executed by at least one processor to implement the antenna control method described in the above embodiments.

After considering the description and practicing the present invention disclosed herein, those skilled in the art are would understand that variations, use or adaptation of the present disclosure, which follow general principles of the present disclosure and include the common general knowledge or frequently used technical means in the technical field, which are not disclosed in the present disclosure, may be applied.

It should be understood that the present disclosure is not necessarily limited to the precise structure described above and shown in the drawings, and various modifications and changes may be made without departing from its scope of the present disclosure.

What is claimed is:

1. An antenna control method, comprising:
determining a number of receiving antennas currently in use; and
changing the number of the receiving antennas currently in use, according to a predetermined condition,
wherein the predetermined condition is related to a Rank Indicator (RI) assigned by a network or Reference Signal Receiving Powers (RSRPs) of the receiving antennas.

2. The antenna control method according to claim 1, further comprising:
restoring or maintaining the number of receiving antennas currently in use to a maximum value based on the receiving antennas being used to receive an amount of data that is above a predetermined threshold.

3. The antenna control method according to claim 1, wherein the changing of the number of receiving antennas currently in use, according to the predetermined condition, comprises:
comparing a value of the RI assigned by the network with the number of receiving antennas currently in use,
decreasing the number of receiving antennas currently in use when the value of the RI is less than the number of receiving antennas currently in use,
maintaining the number of receiving antennas currently in use when the value of the RI is equal to the number of receiving antennas currently in use, and
restoring or maintaining the number of receiving antennas currently in use to the maximum when the value of the RI is greater than the number of receiving antennas currently in use.

4. The antenna control method according to claim 3, wherein the decreasing of the number of receiving antennas currently in use when the value of the RI is less than the number of receiving antennas currently in use comprises:
starting a first timer in response to determining that the value of the RI is less than the number of receiving antennas currently in use; and
decreasing the number of receiving antennas currently in use to the value of the RI when the first timer exceeds a first predetermined time period.

5. The antenna control method according to claim 1, wherein the changing of the number of receiving antennas currently in use, according to the predetermined condition, comprises:
determining a RSRP of each receiving antenna currently used;
determining whether there is one or more receiving antennas satisfying a first condition, based on the RSRP of the each receiving antenna;
turning off the one or more receiving antennas when there is the one or more receiving antennas satisfying the first condition; and
maintaining the number of receiving antennas currently in use of the receiving antennas when there is no one or more receiving antennas satisfying the first condition.

6. The antenna control method according to claim 5, wherein the turning off the one or more receiving antennas comprises:
starting a second timer in response to determining that there is the one or more receiving antennas satisfying the first condition; and
turning off the one or more receiving antennas when the second timer exceeds a second predetermined time period.

7. The antenna control method according to claim 5, wherein the first condition is that, the RSRP of each of the one or more receiving antennas is less than a first RSRP threshold value, and a RSRP difference between each of the one or more receiving antennas and any other receiving antenna is greater than a second RSRP threshold value.

8. The antenna control method according to claim 1, further comprising:
starting a third timer; and
when a third time period timed by the third timer exceeds a third predetermined time period, in response to determining that the number of receiving antennas currently in use is not the maximum, restoring the number of receiving antennas currently in use to the maximum, and restarting the third timer.

9. The antenna control method according to claim 8, wherein the restoring of the number of receiving antennas currently in use to the maximum comprises:
determining whether the value of the RI assigned by the network is greater than the number of receiving antennas currently in use before being restored to the maximum;
maintaining the number of receiving antennas currently in use to the maximum when the value of the RI is greater than the number of receiving antennas currently in use;
restoring the number of receiving antennas currently in use when the value of the RI is not greater than the number of receiving antennas currently in use.

10. The antenna control method according to claim 8, wherein the restoring of the number of receiving antennas currently in use to the maximum further comprises:
determining a RSRP of each receiving antenna;
determining whether all receiving antennas satisfy a second condition based on the RSRP of the each receiving antenna;
restoring the number of receiving antennas currently in use when not all the receiving antennas satisfy the second condition; and
maintaining the number of receiving antennas currently in use to the maximum when all the receiving antennas satisfy the second condition.

11. The antenna control method according to claim 9, wherein the restoring of the number of receiving antennas currently in use further comprises:
starting a fourth timer, in response to determining that the value of the RI is not greater than the number of receiving antennas currently in use or in response to determining that not all the receiving antennas satisfy the second condition; and
restoring the number of receiving antennas currently in use when the fourth timer exceeds a fourth predetermined time period.

12. The antenna control method according to claim 10, wherein the second condition is that the RSRP of each of all the receiving antennas is greater than a third RSRP threshold value, and a RSRP difference between the each receiving antenna and any other receiving antenna is less than a fourth RSRP threshold value.

13. An antenna control device, comprising:
an antenna determination unit configured to determine a number of receiving antennas currently in use; and
an antenna control unit configured to:
change the number of receiving antennas currently in use, according to a predetermined condition,
wherein the predetermined condition is related to a Rank Indicator (RI) assigned by a network or Reference Signal Receiving Powers (RSRPs) of the receiving antennas.

14. The antenna control device according to claim 13, wherein the antenna control unit is further configured to:
restore or maintain the number of receiving antennas currently in use to the maximum based on the receiving antennas being used to receive an amount of data that is above a predetermined threshold.

15. The antenna control device according to claim 13, wherein the antenna control unit is configured to change the number of receiving antennas currently in use , according to the predetermined condition, by:
comparing a value of the RI assigned by the network with the number of receiving antennas currently in use,
decreasing the number of receiving antennas currently in use when the value of the RI is less than the number of receiving antennas currently in use,
maintaining the number of receiving antennas currently in use when the value of the RI is equal to the number of receiving antennas currently in use, and
restoring or maintaining the number of receiving antennas currently in use to the maximum when the value of the RI is greater than the number of receiving antennas currently in use.

16. The antenna control device according to claim 15, wherein when the value of the RI is less than the number of receiving antennas currently in use, the antenna control unit is configured to decrease the number of receiving antennas currently in use by:
starting a first timer in response to determining that the value of the RI is less than the number of receiving antennas currently in use; and
decreasing the number of receiving antennas currently in use to the value of the RI when the first timer exceeds a first predetermined time period.

17. The antenna control device according to claim 13, wherein the antenna control unit is configured to change the number of receiving antennas currently in use , according to the predetermined condition, by:
determining a RSRP of each receiving antenna currently used;
determining whether there is one or more receiving antennas satisfying a first condition, based on the RSRP of the each receiving antenna;
turning off the one or more receiving antennas when there is the one or more receiving antennas satisfying the first condition; and
maintaining the number of receiving antennas currently in use when there is no one or more receiving antennas satisfying the first condition.

18. The antenna control device of claim 17, wherein the antenna control unit is configured to turn off the one or more receiving antennas by:
starting a second timer in response to determining that there is the one or more receiving antennas satisfying the first condition; and
turning off the one or more receiving antennas when the second timer exceeds a second predetermined time period.

19. The antenna control device according to claim 17, wherein the first condition is that the RSRP of each of the one or more receiving antennas is less than a first RSRP threshold value, and a RSRP difference between each of the one or more receiving antennas and any other receiving antenna is greater than a second RSRP threshold value.

20. The antenna control device according to claim 13, wherein the antenna control unit is further configured to:
start a third timer;
when a third time period timed by the third timer exceeds a third predetermined time period, in response to determining that the number of receiving antennas currently in use is not the maximum, restore the number of receiving antennas currently in use to the maximum, and restart the third timer.

21. The antenna control device according to claim 20, wherein the antenna control unit is further configured to recover the number of receiving antennas currently in use to the maximum by:
determining whether the value of the RI assigned by the network is greater than the number of receiving antennas currently in use before being restored to the maximum,
maintaining the number of receiving antennas currently in use to the maximum when the value of the RI is greater than the number of receiving antennas currently in use;
restoring the number of receiving antennas currently in use when the value of the RI is not greater than the number of receiving antennas currently in use.

22. The antenna control device according to claim 20, wherein the antenna control unit is further configured to restore the number of receiving antennas currently in use to the maximum by:
determining a RSRP of each receiving antenna;
determining whether all receiving antennas satisfy a second condition based on the RSRP of the each receiving antenna;
restoring the number of receiving antennas currently in use when not all the receiving antennas satisfy the second condition, and
maintaining the number of receiving antennas currently in use to the maximum when all the receiving antennas satisfy the second condition.

23. The antenna control device according to claim 22, wherein the antenna control unit is further configured to restore the number of receiving antennas currently in use by:
starting a fourth timer, in response to determining that the value of the RI is not greater than the number of receiving antennas currently in use or in response to determining that not all the receiving antennas satisfy the second condition;
restoring the number of receiving antennas currently in use when the fourth timer exceeds a fourth predetermined time period.

24. The antenna control device according to claim 22, wherein the second condition is that the RSRP of each of all the receiving antennas is greater than a third RSRP threshold value, and a RSRP difference between the each receiving antenna and any other receiving antenna is less than a fourth RSRP threshold value.
